(19) United States
(12) Patent Application Publication
(10) Pub. No.: US 2017/0022113 A1
(43) Pub. Date: Jan. 26, 2017

(54) RARE EARTH SILICATE ENVIRONMENTAL BARRIER COATINGS HAVING IMPROVED CMAS RESISTANCE

(71) Applicant: UNIVERSITY OF VIRGINIA PATENT FOUNDATION D/B/A/ UNIVERSITY OF VIRGINIA LICENSING & VENTURES GROUP, Charlottesville, VA (US)

(72) Inventor: Elizabeth OPILA, Charlottesville, VA (US)

(21) Appl. No.: 15/218,867

(22) Filed: Jul. 25, 2016

Related U.S. Application Data
(60) Provisional application No. 62/196,490, filed on Jul. 24, 2015.

(51) Int. Cl. C04B 35/50; C04B 41/52; C04B 41/87; C04B 41/50; C04B 35/565; C04B 35/622

(52) U.S. Cl. CPC C04B 35/50; C04B 35/565; C04B 35/62222; C04B 41/87; C04B 41/5024; C04B 41/5041; C04B 41/52; C04B 2235/3826; C04B 2235/3427; C04B 2235/3234

(57) ABSTRACT

An environmental barrier coating having improved CMAS resistance for a ceramic matrix composite, an article comprising an environmental barrier coating having improved CMAS resistance, and a method of forming an environmental barrier coating having improved CMAS resistance are disclosed. The environmental barrier coating may include a rare earth silicate and a rare earth titanate. The ceramic matrix composite may be a silicon carbide-based composite.

### CROSS-REFERENCE TO RELATED APPLICATIONS

This application claims benefit of priority of U.S. Provisional Patent Application No. 62/196,490, filed Jul. 24, 2015, which is incorporated herein by reference.

### TECHNICAL FIELD

The present disclosure is directed to an environmental barrier coating and, more particularly, to a rare earth silicate environmental barrier coating having improved CMAS resistance.

### BACKGROUND

During operation of a turbine engine, the engine's blades may be regularly subject to contact with ingested particulate matter. Such particulate matter is commonly referred to as “CMAS,” an acronym derived from the CaO—MgO—Al₂O₃—SiO₂ constituents that make up common earth forming compounds, also referred to as Calcium-Magnesium AluminoSilicates. CMAS melts at about 1200° C. (though the melting temperature may vary depending on exact CMAS composition) and can form deposits on the surface of turbine blades, which may be formed of SiC-based Ceramic Matrix Composites (CMCs). Environmental Barrier Coatings (EBCs), which may comprise a rare earth silicate, are being developed for the protection of CMCs against the damaging effects of water vapor in combustion environments. There is also an interest in developing EBCs for CMCs exposed to higher operating temperatures than current state-of-the art Yttria-Stabilized Zirconia (YSZ) Thermal Barrier Coated (TBC) Ni-base superalloys.

One concern with use of EBC/CMCs at higher operating temperatures is EBCs may be damaged by reactions with CMAS deposits. At high operating temperatures, molten CMAS can deposit and react with EBCs, which can result in the loss of the EBC, thereby damaging the CMC. Strategies to mitigate the damage caused by CMAS reactions with EBCs include inducing crystallization of the CMAS and resulting consumption of the glassy phase. Attempts to promote crystallization of CMAS on Thermal Barrier Coatings (TBCs) by the addition of TiO₂ to the TBC compounds have been conducted in the past. However, TBC compounds are generally quite different from EBC compounds, resulting in different reactions with CMAS. Thus the resistance of EBC to damage from reactions with CMAS may yet be improved.

### SUMMARY

In one aspect, the present disclosure is directed to an environmental barrier coating (EBC) for a ceramic matrix composite (CMC). The EBC may include a rare earth silicate and a rare earth titanate.

In another aspect, the present disclosure is directed to an article comprising a CMC. The article may further include an EBC disposed on the CMC, and the EBC may include a rare earth silicate and a rare earth titanate.

In yet another aspect, the present disclosure is directed to a method of forming an EBC for a CMC. The method may include providing a rare earth silicate, providing a rare earth titanate, and applying the rare earth silicate and the rare earth titanate to the CMC. The CMC may comprise silicon carbide (SiC).

### BRIEF DESCRIPTION OF THE DRAWINGS

FIG. 1 shows a phase diagram for an exemplary SiO₂ TiO₂ system;

FIG. 2 shows a phase diagram for an exemplary Y₂O₃—SiO₂ EBC system;

FIG. 3 shows a comparative binary phase diagrams for Y-silicates and Yb-silicates that is consistent with embodiments of the present disclosure;

FIG. 4 shows a comparative binary phase diagrams for exemplary RE titanates that are consistent with embodiments of the present disclosure;

FIG. 5 shows an exemplary crystalline phase formation consistent with embodiments of the present disclosure;

FIG. 6 shows exemplary crystalline phase formations consistent with embodiments of the present disclosure;

FIG. 7 shows exemplary crystalline phase structures consistent with embodiments of the present disclosure;

FIG. 8 shows wt % with respect to time and an image of exemplary RE titanates consistent with embodiments of the present disclosure;

FIG. 9 shows wt % with respect to time for exemplary RE titanates consistent with embodiments of the present disclosure;

FIG. 10 shows phase profiles during cooling of exemplary RE titanates consistent with embodiments of the present disclosure; and

FIG. 11 shows phase profiles during cooling of an exemplary RE titanate consistent with embodiments of the present disclosure.

### DETAILED DESCRIPTION

SiC-based CMCs are under development for hot-section components in advanced turbine engines to provide increased efficiencies resulting from higher operating temperatures and lower weight than current superalloys. SiC oxidizes to form silica (SiO₂) in hot-section combustion environments, and this silica simultaneously reacts with water vapor formed as a product of combustion. Volatilization of the silica then occurs via the following reaction:

SiO₂+2H₂O(g)=Si(OH)₄(g) EQ. 1

This volatilization reaction results in unacceptably rapid recession of the underlying SiC component. EBCs can be used to mitigate the rapid recession and enable use of CMCs in turbine engines at higher temperatures. The EBC coatings may contain silica (i.e., they may be silica-based or SiC-based) for chemical compatibility with the SiC components of CMCs. Some EBCs are composed of Rare Earth (RE) silicates which are also susceptible to water-vapor induced recession (though recession RE silicates may occur at lower rates than SiC). Additionally, CMAS can be ingested into the turbine, deposit on the turbine hot-sections, and react to form low melting phases that degrade EBCs.

To improve the resistance of SiC-based EBCs to damage caused by reactions with CMAS, RE titanate may be added to RE silicate compositions, as discussed below. CMAS can dissolve RE silicate coatings to form an apatite phase with excess silica. Additional CMAS can then penetrate the glassy grain boundaries in the reaction molten product between CMAS and RE silicate coatings, thereby enabling the dissolution reaction to continue. By promoting crystallization of amorphous grain boundaries in the apatite reaction product, resistance of RE silicates in EBCs to reactions with CMAS can be improved.

Adding TiO₂ to EBC compounds, such as RE silicates, may promote crystallization of the glassy reaction product between CMAS and RE silicates. Suitable RE silicates may be of the form RE₂Si₂O₇ or RE₂SiO₅ where RE is, for example, one of ytterbium (Yb), yttrium (Y), gadolinium (Gd), praseodymium (Pr), dysprosium (Dy), holmium (Ho), erbium (Er), and lutetium (Lu). For example, in some embodiments, the RE silicate may be one of Yb₂Si₂O₇, Yb₂SiO₅, Y₂Si₂O₇, and Y₂SiO₅.

As mentioned above, adding TiO₂ to the EBC may promote crystallization of the glassy reaction product between CMAS and RE silicates. For example, adding 2-20 wt % of TiO₂ to the glassy reaction product may promote crystallization. The solubility of TiO₂ may vary at different temperatures, thereby creating variability in the level of crystallization for a given wt % of TiO₂. For example, in some embodiments, 2-20 wt % may be used. In other embodiments, 5-15 wt % may be used. In other embodiments, 10 wt % or greater may be used. It is noted that a higher or lower wt % of TiO₂ may be used based on temperature and the particular EBC compound to which TiO₂ is added.

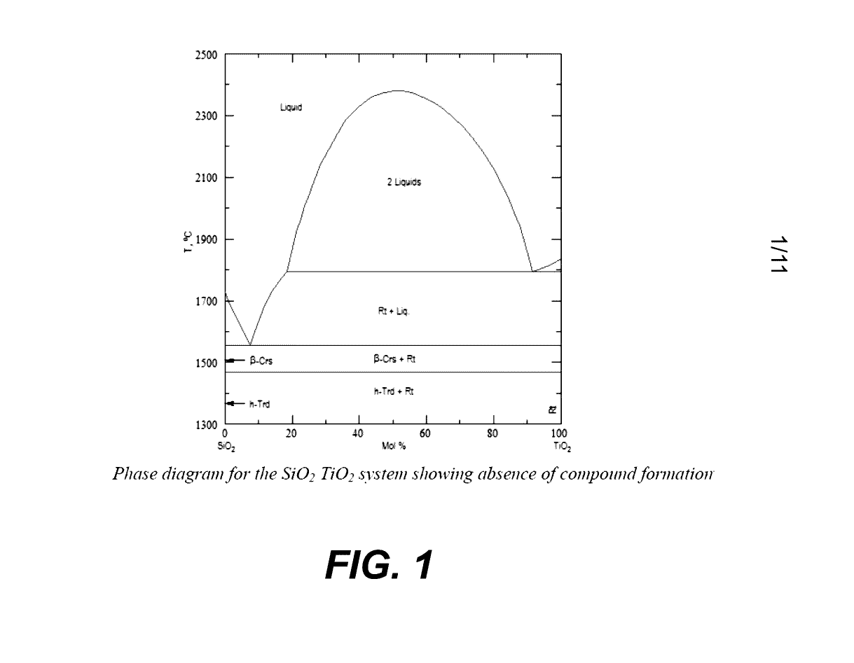

In some embodiments, a TiO₂-containing EBC system may be used. Due to the phase equilibria in the SiO₂TiO₂ system in which no titanium silicate compounds exist, as shown in FIG. 1 TiO₂ tends to precipitate out of glassy melts. Crystalline TiO₂ precipitates may act as heterogeneous nuclei that promote crystallization. In other embodiments, TiO₂ may also or alternatively be added to yttrium silicate material solutions to achieve similar results.

The addition of RE titanates rather than pure TiO₂ may provide extra rare earth materials to the system chemistry. The extra rare earth materials can react with excess silica from the CMAS reaction with RE silicate, which can crystallize the additional free silica. As described above, TiO₂ may be added at 2-20 wt % to the EBC to promote crystallization. It is noted, however, that crystallization can be achieved using mixtures of varying ratios of TiO2 and CMAS. For example, crystallization experienced using different wt % of TiO₂ can be observed using DSC (Netszch STA-449 F1), XRD (Panalytical Xpert), and SEM/EDS (JEOL 6700F) to determine crystallization temperature, extent of crystallization, and crystalline phases and morphologies.

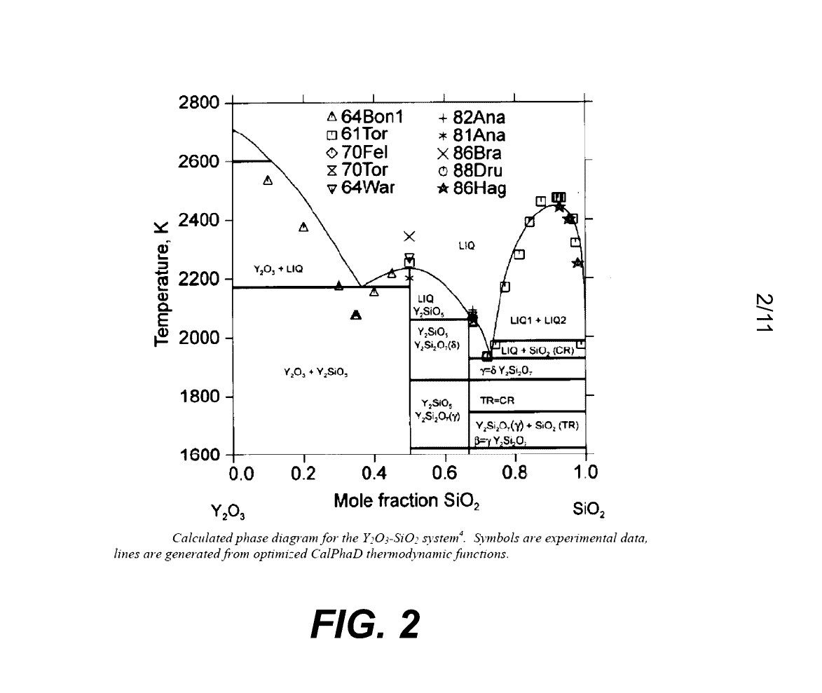

In some embodiments, TiO₂ may be mixed with Y₂O₃ in varying ratios to form RE titanates. Resulting titanates may be characterized by XRD and SEM/EDS, as described above. Comparison can be made to the existing phase diagram shown in FIG. 2 to determine if equilibrium phases form. The phase diagram shows the di-titanate Y₂Ti₂O₇ (pyrochlore and fluorite structures) and mono-titanate Y₂TiO₅ (orthorhombic or hexagonal) as stable phases, though others may be possible. For instance, the perovskite phase YTiO₃ may be stable.

Suitable RE titanates that may be added to EBCs may be of the form RE₂Ti₂O₇ or RE₂TiO₅, where RE is one of, for example, ytterbium (Yb), yttrium (y), dysprosium (Dy), erbium (Er), and lutetium (Lu). In some embodiments, for example, the RE titanate may be one of Yb₂Ti₂O₇, Yb₂TiO₅, Y₂Ti₂O₇, and Y₂TiO₅. Commercially available RE titanates may be used. Alternatively, RE titanates prepared from constituent oxide powders may be used.

The addition of an RE titanate to the EBC may provide, among other things, two advantageous results: 1) the TiO₂ reaction with the CMAS may form crystalline phases such as CaTiO₃, and 2) the RE oxide reaction with remaining SiO₂ from the CMAS may form RE silicates, which is the phase of the underlying coating. In other words, adding RE titanates instead of only TiO₂ may improve crystallization and CMAS resistance through reactions of CMAS with TiO₂ as well as by reacting additional SiO₂ with RE elements. In this way, SiO₂ may be removed from the CMAS melt and pulled into crystalline phase. Additionally, CaO may also be removed from the melt and pulled into crystalline phase, which may increase the viscosity of the melt. Thus, adding RE titanates to SiC-based EBCs may promote crystallization of CMAS on CMCs by nucleation more quickly and at higher temperatures.

A method of forming an EBC for a CMC consistent with embodiments of this disclosure may include the steps of providing a RE silicate, providing a RE titanate, and applying the RE silicate and the RE titanate to the CMC. In some embodiments, the CMC may include silicon carbide (i.e., it may be a silicon carbide-based or SiC-based ceramic matrix composite). Other types of CMCs may be possible.

In some embodiments, the method may include providing a RE silicate of the form RE₂Si₂O₇ or RE₂SiO₅, where RE is a rare earth element. It is noted that other forms of RE silicates may be used. In some embodiments, the RE silicate may comprise a RE element, such as one of ytterbium (Yt), yttrium (Y), gadolinium (Gd), praseodymium (Pr), dysprosium (Dy), holmium (Ho), erbium (Er), and lutetium (Lu). For example, in some embodiments, the method may include providing one of Yb₂Si₂O₇, Yb₂SiO₅, Y₂Si₂O₇, and Y₂SiO₅. It is noted that other RE elements may be used.

In some embodiments, the method may include providing a RE titanate of the form RE₂Ti₂O₇ or RE₂TiO₅, where RE is a rare earth element. It is noted that other forms of RE titanates may be used. In some embodiments, the RE titanate may comprise a RE element, such as one of ytterbium (Yt), yttrium (Y), dysprosium (Dy), erbium (Er), and lutetium (Lu). For example, in some embodiments, the method may include providing Yb₂Ti₂O₇, Yb₂TiO₅, Y₂Ti₂O₇, and Y₂TiO₅. It is noted that other RE elements may be used.

Embodiments of the present disclosure may be exemplified in an article, such as a turbine blade, vane, shroud, combustor liner or other component. The article may comprise, for example, a CMC and an EBC disposed on the CMC. In some embodiments, the ceramic matrix composite may include silicon carbide (i.e., it may be a silicon carbide-based or SiC-based ceramic matrix composite). Other types of CMCs may be possible.

The EBC of the article may include a RE silicate and a RE titanate. In some embodiments, the article may include a RE silicate of the form RE₂Si₂O₇ or RE₂SiO₅, where RE is a rare earth element. It is noted that other forms of RE silicates may be used. In some embodiments, the RE silicate may comprise at least one RE element, such as at least one of ytterbium (Yt), yttrium (Y), gadolinium (Gd), praseodymium (Pr), dysprosium (Dy), holmium (Ho), erbium (Er), and lutetium (Lu). For example, in some embodiments, the article may include one of Yb₂Si₂O₇, Yb₂SiO₅, Y₂Si₂O₇, and Y₂SiO₅. It is noted that other RE elements may be used.

In some embodiments, the article may include a RE titanate of the form RE₂Ti₂O₇ or RE₂TiO₅, where RE is a rare earth element. It is noted that other forms of RE titanates may be used. In some embodiments, the RE titanate may comprise at least one RE element, such as at least

one of ytterbium (Yt), yttrium (Y), dysprosium (Dy), erbium (Er), and lutetium (Lu). For example, in some embodiments, the article may include Yb₂Ti₂O₇, Yb₂TiO₅, Y₂Ti₂O₇, and Y₂TiO₅. It is noted that other RE elements may be used.

### Experiments

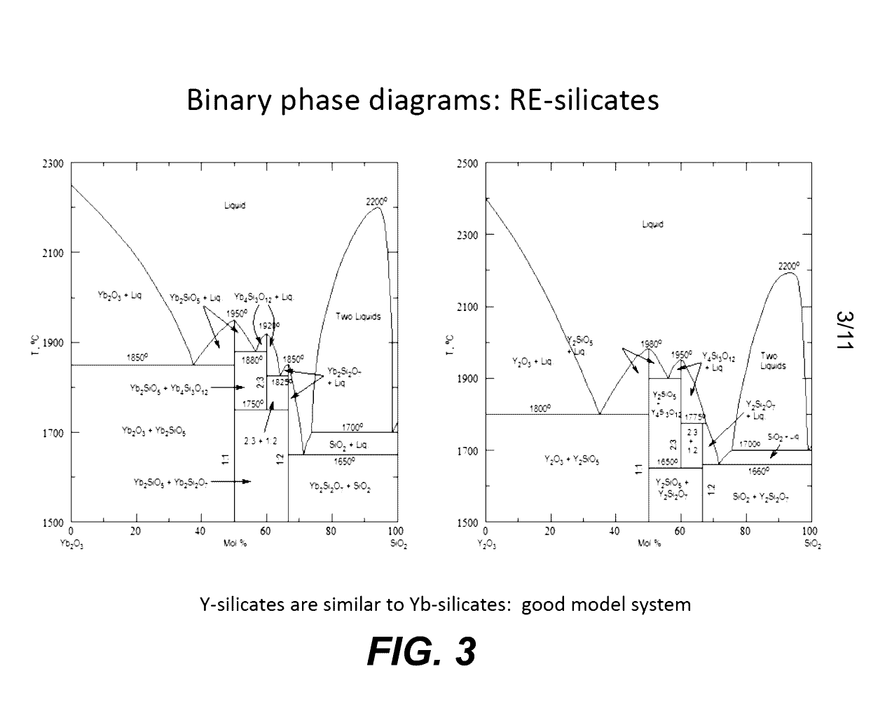

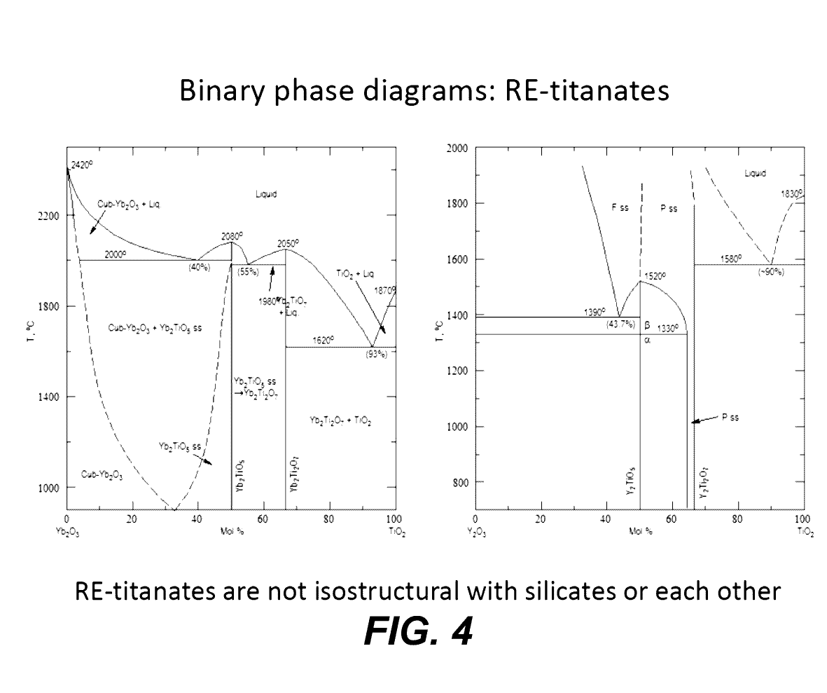

Experiments conducted in accordance with certain embodiments of the present disclosure were performed. Although other silicates may be used in embodiments consistent with the present disclosure, experiments were conducted using Yb₂Si₂O₇ (monoclinic), Yb₂SiO₅ (monoclinic), Y₂Si₂O₇ (tetragonal, orthorhombic, monoclinic), and Y₂SiO₅ (monoclinic) silicates. Comparative binary phase diagrams for these silicates are shown in FIG. 3. Similarly, while other titanates may be used in embodiments consistent with the present disclosure, experiments were conducted using Yb₂Ti₂O₇ (cubic pyrochlore), Yb₂TiO₅ (fluorite), Y₂Ti₂O₇ (cubic pyrochlore), and Y₂TiO₅ (orthorhombic, hexagonal, fluorite). Comparative binary phase diagrams for these titanates are shown in FIG. 4.

Compositional effects based on the amount of TiO₂ used in compositions, as well as temperature profiles (e.g., heating/cooling ramp profiles and “flight profiles”) of RE titanates, RE silicates, and CMAS were studied. Heating was conducted via furnace exposure using a box furnace, and resultant compositions were characterized using XRD, LM, SEM/EDS, and Advanced Photon Source/Argonne National Lab.

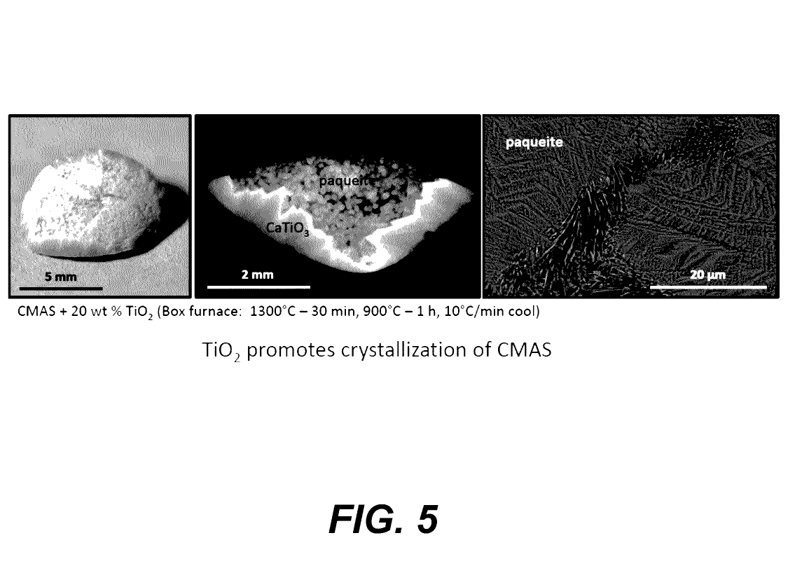

Experimental additions of 20 wt % TiO₂ to CMAS were generated. The mixture was heated in a box furnace at 1300° C. for 30 minutes, at 900° C. for 1 hour, and was cooled at 10° C./min. Characterization of the resultant compound showed promotion of the formation of the crystalline phase, as shown in FIG. 5. The characterization included CaTiO₃ shore, paqueite Ca₃TiSi₂ (Al, Ti, Si)₃O₁₄ islands, and diopside Ca(Mg, Al)[(Si, Al)₂O₆].

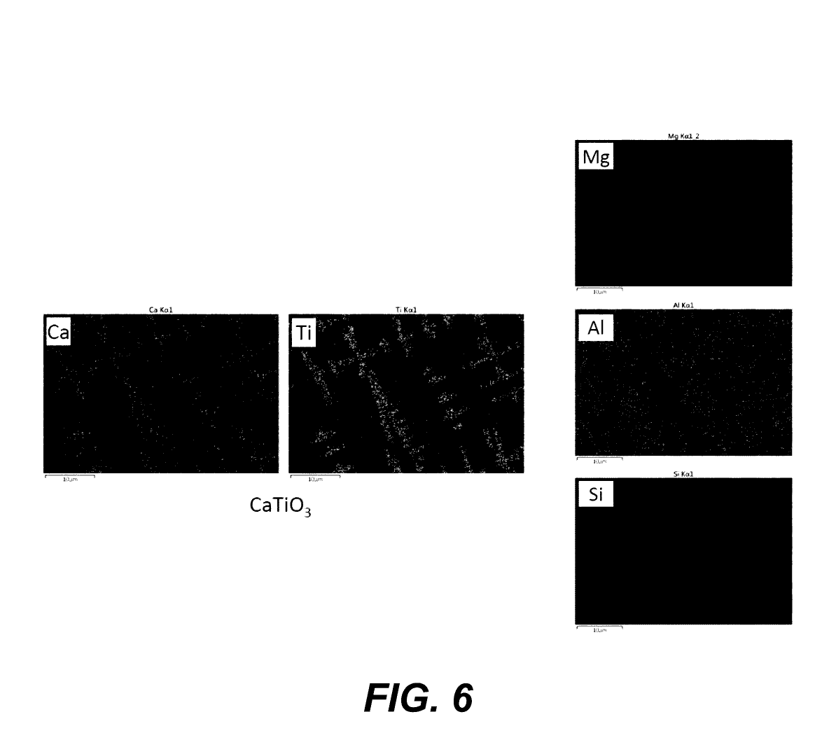

In another phase of experimentation CMAS+20TiO₂ was heated in a ramped profile at 1300° C. for 10 minutes and cooled at 10° C. per minute. EDS mapping of the resultant compound indicated that TiO₂ was consumed in CaTiO₃, some CaO remained in the glass phase, and all of MgO, Al₂O₃, and SiO₂, were found in the glass phase. The results are shown in FIG. 6. EDS line scans indicated that about 5 wt % TiO₂ to CMAS is soluble in the glass phase, CaO was reduced by about 6 wt % relative to bulk CMAS composition, MgO, Al₂O₃, and SiO₂ were enriched in glass near CaTiO₃ due to CaO depletion, and CaO is depleted within the entire dendrite region.

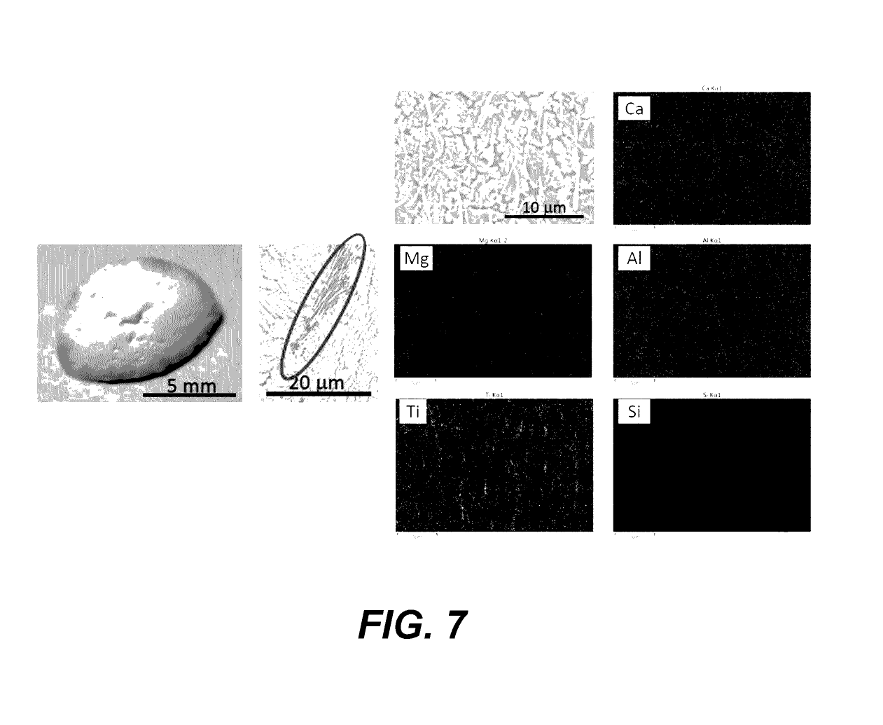

In another phase of experimentation, CMAS+20TiO₂ was heated in a flight profile at 1500° C. for 30 minutes, then 900° C. for 5.5 hours, and cooled at 10° C. per minute. Resultant pellet center regions between paqueite showed diopside, TiO₂, paqueite, and SiO₂-rich glass. Resultant structures are shown in FIG. 7.

RE titanates used in experiments (Y₂TiO₅ (YMT), Yb₂TiO₅ (YbMT), Y₂Ti₂O₇ (YDT), Yb₂Ti₂O₇ (YbDT)) were prepared from constituent oxide powders. It is noted that commercially available titanates may alternatively be used. Titanates combined with SiO₂ were heated at 1300° C. for 100 hours. Results indicate that Y₂Ti₂O₇ does not react with SiO₂ to form any additional crystalline phases, and that Y₂TiO₅ does react with SiO₂ to form crystalline phases.

Reactions of RE titanates and CMAS were carried out by mixing RE titanate powders mixed with CMAS in a 70:30 wt % ratio. The mixture was heated in Pt-5% Au crucibles at 1300° C. for 10 minutes, 4 hours, 24 hours, and 96 hours. The phase fraction of RE titanate remaining was determined with XRD using the Reference Intensity Ratio (RIR) method with α-Al₂O₃ as a reference.

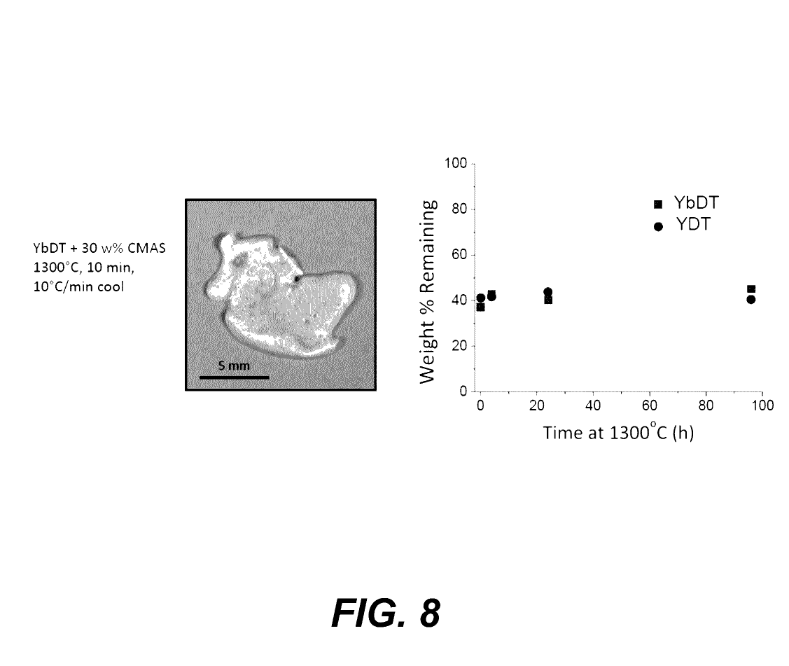

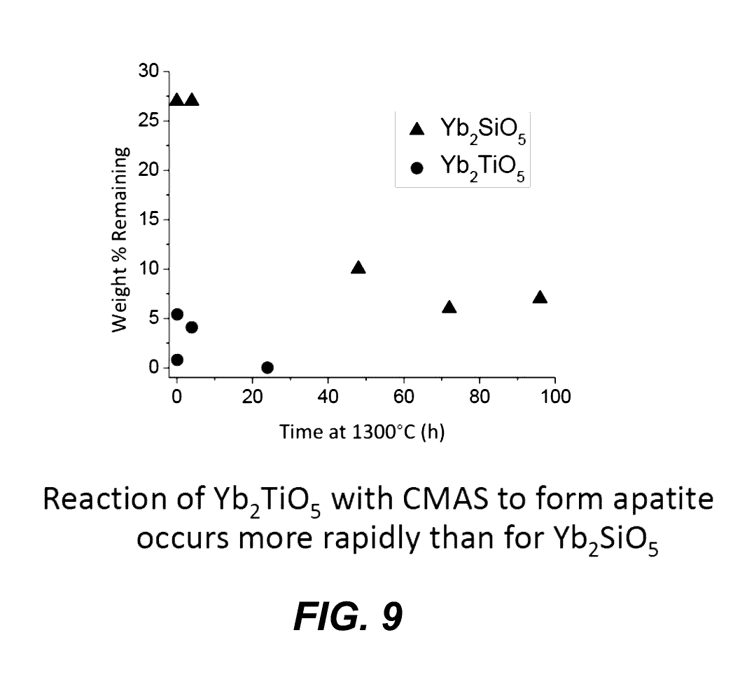

Both Y₂Ti₂O₇ and Yb₂Ti₂O₇ quickly dissolved in the melt and appear to saturate it in less than or equal to 10 minutes. No crystalline reaction products were formed. The wt % remaining of YbDT and YDT over time at 1300° C. from 0 to 96 hours is shown in FIG. 8. Re₂Ti₂O₇ quickly dissolved in CMAS to saturation, and approximately 40 wt % remained after the heat treatment. Similar results were obtained at 1500° C. It was found that Y₂TiO₅ and Yb₂TiO₅ react with CMAS to form crystalline phases in less than or equal to 10 min to form apatite Ca₂RE₈(SiO₄)₆O₂, RE₂Ti₂O₇, and garnet (YMT only). It was also found that the reaction of Yb₂TiO₅ with CMAS to form apatite occurs more rapidly than for Yb₂SiO₅, as shown in FIG. 9.

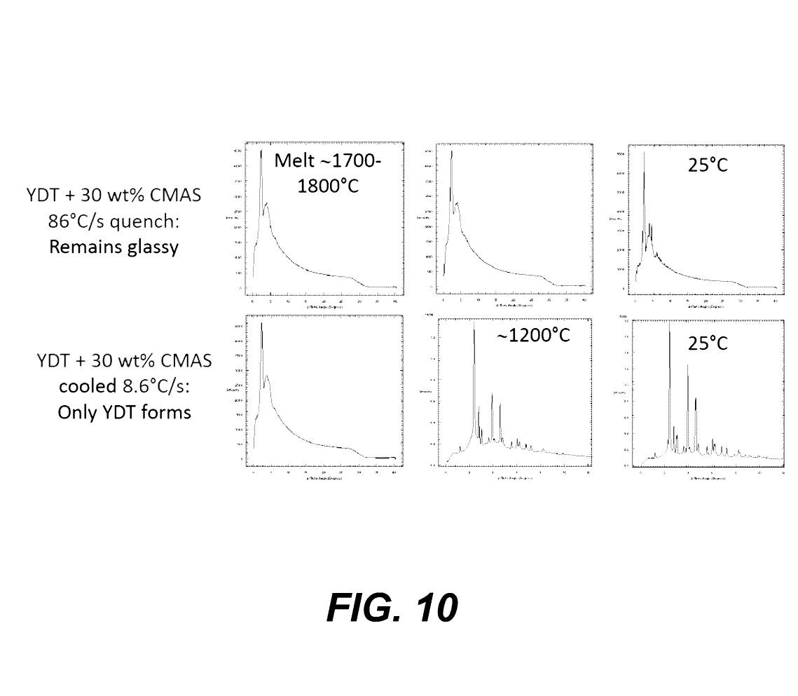

FIG. 10 shows results of Y₂Si₂O₇+20 wt % CMAS that was levitated in air, melted, cooled, in Advanced Photon Source while XRD spectra was acquired. The results show that YDT+30 wt % CMAS that was quenched at 86° C./s remained glassy while YDT+30 wt % CMAS that was cooled at 8.6° C./s remained as YTD. All RE titanates+CMAS melted between 1700-1800° C., which shows a reduction by about 200° C. in melt temperature. Also, YDT+CMAS was shown to remain amorphous during fast cool and that no new phases formed as a result of a moderately fast cool.

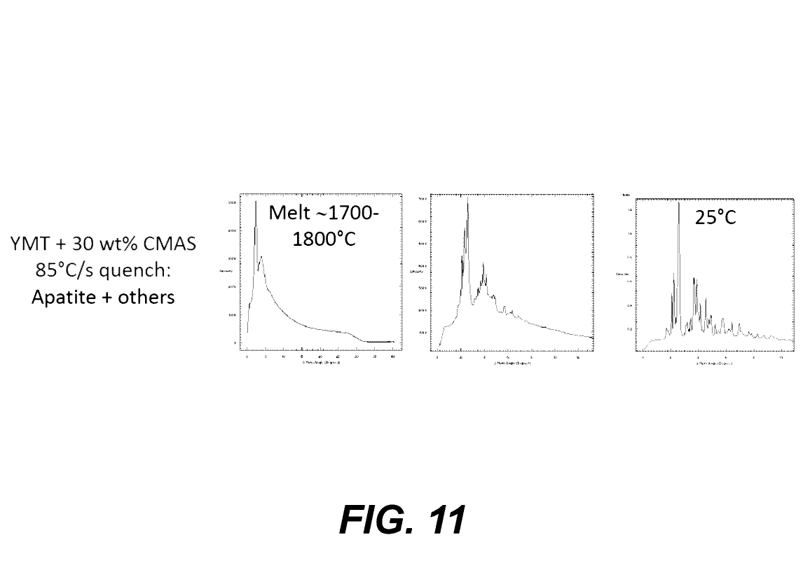

FIG. 11 shows results for Y₂SiO₅+30 wt % CMAS that was levitated in air, and melted cooled in Advanced Photon Source while XRD spectra was acquired. The results show that YMT+30 wt % CMAS quenched at 85° C./s formed apatite and other phases. Also, YMT+CMAS was shown to form apatite plus YDT and other phases during quenching, and that rapid crystallization is favorable for mitigation of CMAS.

What is claimed is:

1. An environmental barrier coating for a ceramic matrix composite, comprising:
a rare earth silicate; and
a rare earth titanate.

2. The environmental barrier coating of claim 1, wherein the rare earth silicate is of the form RE₂Si₂O₇ or RE₂SiO₅, where RE is a rare earth element.

3. The environmental barrier coating of claim 1, wherein the rare earth silicate comprises at least one of ytterbium, yttrium, gadolinium, praseodymium, dysprosium, holmium, erbium, and lutetium.

4. The environmental barrier coating of claim 1, wherein the rare earth silicate is one of Yb₂Si₂O₇, Yb₂SiO₅, Y₂Si₂O₇, and Y₂SiO₅.

5. The environmental barrier coating of claim 1, wherein the rare earth titanate is of the form RE₂Ti₂O₇ or RE₂TiO₅, where RE is a rare earth element.

6. The environmental barrier coating of claim 1, wherein the rare earth titanate comprises at least one of ytterbium, yttrium, dysprosium, erbium, and lutetium. The environmental barrier coating of claim 1, wherein the rare earth titanate is one of Yb₂Ti₂O₇, Yb₂TiO₅, Y₂Ti₂O₇, and Y₂TiO₅.

8. An article, comprising:
a ceramic matrix composite; and
an environmental barrier coating disposed on the ceramic matrix composite,
wherein the environmental barrier coating includes:
a rare earth silicate; and
a rare earth titanate.

9. The article of claim 8, wherein the ceramic matrix composite comprises silicon carbide.

10. The article of claim 8, further comprising an earth forming compound disposed on the environmental barrier coating, the earth forming compound comprising one or more of calcium oxide, magnesium oxide, aluminum oxide, and silicon oxide.

11. The article of claim 8, wherein the rare earth silicate is of the form RE₂Si₂O₇ or RE₂SiO₅, where RE is a rare earth element.

12. The article of claim 8, wherein:
the rare earth silicate comprises at least one of ytterbium, yttrium, gadolinium, praseodymium, dysprosium, holmium, erbium, and lutetium; and
the rare earth titanate comprises at least one of ytterbium, yttrium, dysprosium, erbium, and lutetium.

13. The article of claim 8, wherein the rare earth silicate is one of Yb₂Si₂O₇, Yb₂SiO₅, Y₂Si₂O₇, and Y₂SiO₅.

14. The article of claim 8, wherein the rare earth titanate is of the form RE₂Ti₂O₇ or RE₂TiO₅, where RE is a rare earth element.

15. The article of claim 8, wherein the rare earth titanate is one of Yb₂Ti₂O₇, Yb₂TiO₅, Y₂Ti₂O₇, and Y₂TiO₅.

16. A method of forming an environmental barrier coating for a ceramic matrix composite, comprising:
providing a rare earth silicate;
providing a rare earth titanate; and
applying the rare earth silicate and the rare earth titanate to the ceramic matrix composite, wherein the ceramic matrix composite comprises silicon carbide.

17. The method of claim 16, wherein the rare earth silicate is of the form RE₂Si₂O₇ or RE₂SiO₅, where RE is a rare earth element.

18. The method of claim 16, wherein the rare earth titanate is of the form RE₂Ti₂O₇ or RE₂TiO₅, where RE is a rare earth element.

19. The method of claim 16, wherein:
the rare earth silicate comprises at least one of ytterbium, yttrium, gadolinium, praseodymium, dysprosium, holmium, erbium, and lutetium; and
the rare earth titanate comprises at least one of ytterbium, yttrium, dysprosium, erbium, and lutetium.

20. The method of claim 16, wherein:
the rare earth silicate is one of Yb₂Si₂O₇, Yb₂SiO₅, Y₂Si₂O₇, and Y₂SiO₅; or
the rare earth titanate is one of Yb₂Ti₂O₇, Yb₂TiO₅, Y₂Ti₂O₇, and Y₂TiO₅.
